(19) United States
(12) Patent Application Publication
(10) Pub. No.: US 2015/0211295 A1
(43) Pub. Date: Jul. 30, 2015

(54) CURTAINS

(71) Applicant: CHICOLOGY, INC., Industry, CA (US)

(72) Inventor: Ju-Huai Chen, Industry, CA (US)

(73) Assignee: CHICOLOGY, INC., Industry, CA (US)

(21) Appl. No.: 14/166,613

(22) Filed: Jan. 28, 2014

(51) Int. Cl. E06B 9/56

(52) U.S. Cl. CPC E06B 9/56

(57) ABSTRACT

A curtain includes a storage module, a rear unit and a screen. The storage unit has a first fixing unit, a second fixing unit, a shaft and a driving unit. The curtain fixes to a wall by the first fixing unit and the second fixing unit. One end of the shaft is fixed to the first fixing unit. The driving unit has an elastic unit and a rotating shaft which are set on the second fixing unit. The opposite end of the shaft is connected to the rotating shaft. The rear unit has a first connecting part, a second connecting part and a plurality of first sticking parts. The first connecting part connects to the shaft. The screen has a plurality of second sticking parts. The second sticking parts stick to the first sticking part correspondingly to form a roman shades by the screen on the rear unit.

### BACKGROUND OF THE INVENTION

1. Field of the Invention

The present invention relates to curtains, more particularly to dual-axis roman shades which is controlled axially.

2. Description of the Related Art

There are many kinds of curtains in nowadays, so how to make beautiful curtains to attract users is very important and gorgeous roman shades is a good choice.

However, the manufacturing process of the traditional roman shades is very complicated, even sometimes it needs to be made manually. If the curtains are made manually, it can't have mass production and the quality of the curtains will be differed.

Moreover, the roman shades have at least one axis having an up-down unit to form a curtain for the users to pull up or pull down the roman shades. The roman shades can be storage on the axis by the user who operates the up-down unit. But because the up-down unit can't be exerted equally on the axis, the speed of the two sides of the roman shades stored to the axis is different and then the two sides of the roman shades will be on the different heights.

### SUMMARY OF THE INVENTION

The primary object of the invention is to provide a kind of curtain which includes a rear unit and a screen that the rear unit and the screen can be piled together to be roman shades, wherein the rear unit and the screen can be cloth, nylon, plastics or silk.

The other object of the said curtain which includes a storage module to pull up or pull down the roman shades.

The other object of the said curtain is to stick the screen to the rear unit at a distance by coating technique (like heat coating technique) and a plurality of spaces is formed between the rear unit and the screen, wherein the spaces are piled by wave type.

In order to achieve the objectives, a curtain is disclosed which includes a storage module, a rear unit and a screen. The storage unit has a first fixing unit, a second fixing unit, a shaft and a driving unit. The curtain fixes to a wall by the first fixing unit and the second fixing unit. One end of the shaft is fixed to the first fixing unit. The driving unit has an elastic unit and a rotating shaft which are set on the second fixing unit. The opposite end of the shaft is connected to the rotating shaft. The rear unit has a first connecting part, a second connecting part and a plurality of first sticking parts. The first connecting part connects to the shaft and the first sticking parts at a distance of a first length. The screen has a plurality of second sticking parts which stick to the first sticking parts and the second sticking parts are at a distance of a second length which is longer than the first length to form a roman shades by the screen on the rear unit. The rear unit and the screen are stored in the storage module by the elastic unit and the rotating shaft and leave from the rotating shaft.

### BRIEF DESCRIPTION OF THE DRAWINGS

The invention will be described according to the appended drawings in which:

FIG. 1 shows the first embodiment of a construction drawing of curtains.

FIG. 2 shows a construction drawing of the driving unit in FIG. 1.

FIG. 3 shows construction drawing of the rear unit in FIG. 2.

FIG. 4 shows another construction drawing of the storage module in FIG. 1.

FIG. 5 shows the second embodiment of a construction drawing of curtains.

### PREFERRED EMBODIMENT OF THE PRESENT INVENTION

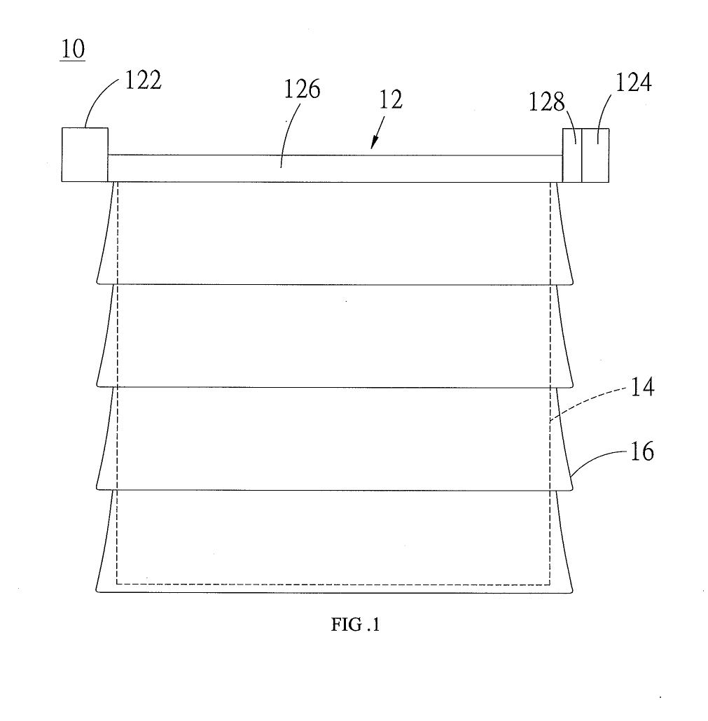

FIG. 1 shows the first embodiment of a construction drawing of curtains. In FIG. 1, the curtain 10 includes a storage module 12, a rear unit 14 and a screen 16.

The storage module 12 further includes a first fixing unit 122, a second fixing unit 124, a shaft 126 and a driving unit 128. The rear unit 14 and the screen 16 are stored in the storage module 12 and unfolded by the driving unit 128.

The curtain 10 fixes to a wall (not showed) by the first fixing unit 122 and the second fixing unit 124. In this embodiment, the shapes of the first fixing unit 122 and the second fixing unit 124 are “L” which the short part is fixed to the wall and the long part is fixed to the shaft 126 and the driving part 128.

One end of the shaft 126 is fixed to the first fixing unit 122 and the opposite end of the shaft 126 is connected to the driving part 128.

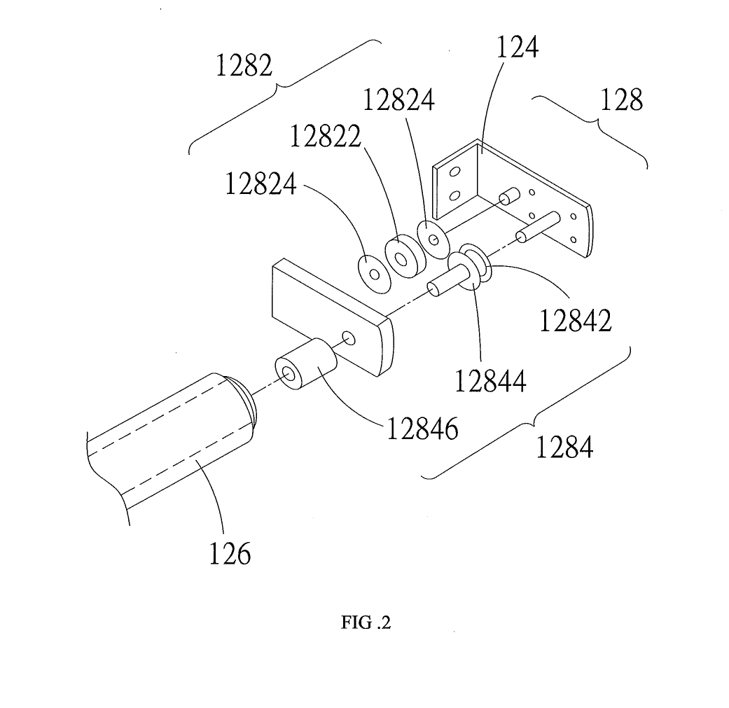

Referring to FIG. 2, the driving part 128 includes an elastic unit 1282 and a rotating unit 1284 which are set on the second fixing unit 124.

The elastic unit 1282 includes a spring 12822 and two blocks 12824. One end of the spring 12822 is set on the second fixing unit 124 and the opposite end of the spring 12822 is set on the rotating shaft 1284.

The rotating shaft 1284 includes a rolling unit 12842, an axis 12844 and a linking-up unit 12846. The rolling unit 12842 connects to the spring 1282 and the axis 12844 combines with the rolling unit 12842. One side of the linking-up unit 12846 connects to the axis 12844 and the other side of the linking-up unit 12846 connects to the shaft 126.

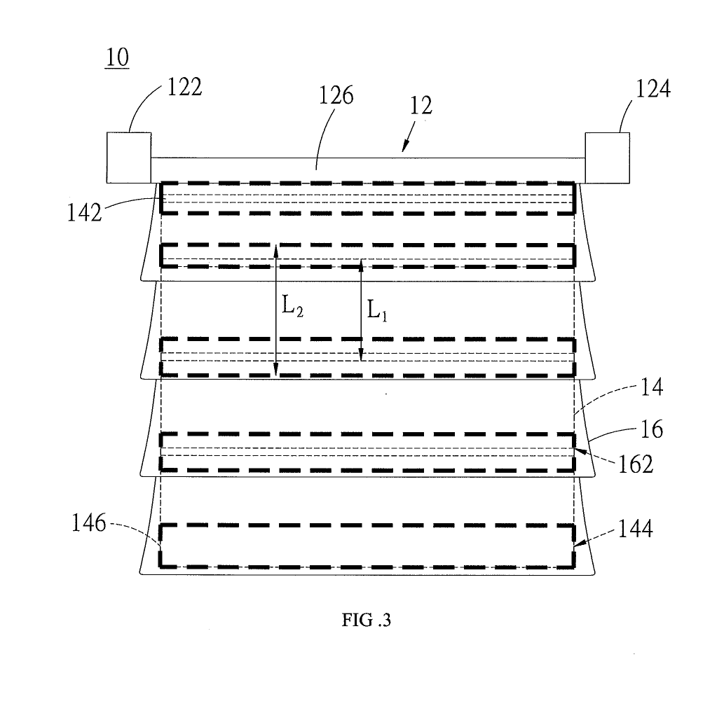

Referring to FIG. 3, the rear unit 14 has a first connecting part 142, a second connecting part 144 and a plurality of first sticking parts 146. The first connecting part 142 connects to the shaft 126 and the first sticking parts 146 at a distance of a first length L1.

The screen 16 has a plurality of second sticking parts 162 which stick to the first sticking parts 146 and the second sticking parts 162 are at a distance of a second length L2 which is longer than the first length L1 to form a roman shades by the screen 16 on the rear unit 14.

It is noticed that the curtain 10 further includes colloid (not showed) which can make the rear unit 14 and the screen 16 stick together.

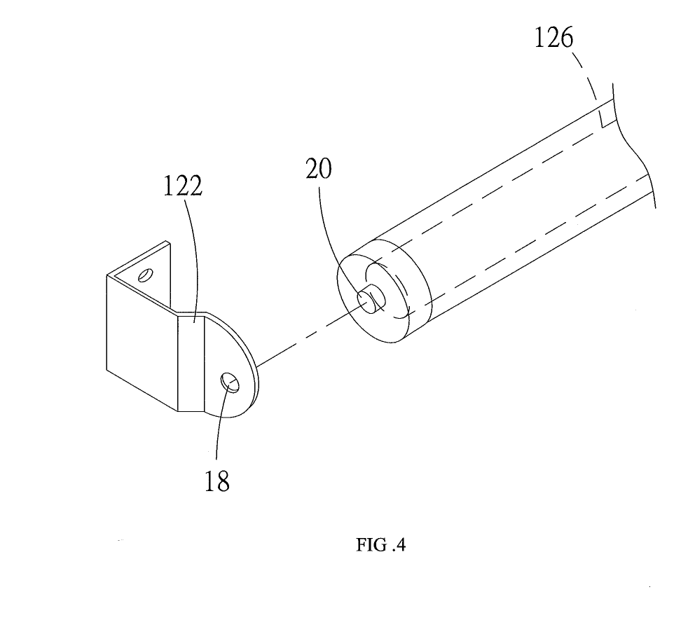

Referring to FIG. 4, the curtain 10 further includes a hole 18 and a telescopic axis 20. The hole 18 is set on the first fixing unit 122 and the telescopic axis 20 is set on the shaft 126, wherein the telescopic axis 20 is closed to the hole 18 and the telescopic axis 20 connects to the hole 18 oppositely.

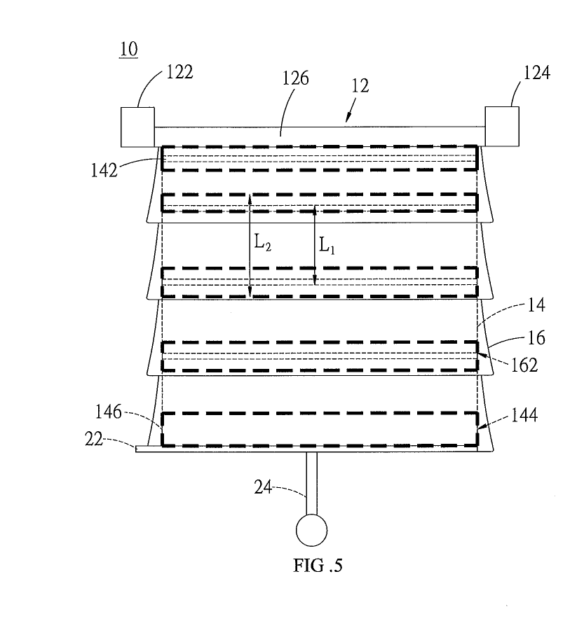

FIG. 5 shows the second embodiment of a construction drawing of curtains. In FIG. 5, the curtain 10′ also includes the storage module 12, the rear unit 14 and the screen 16 which are in the first embodiment, but it further includes a gravity part 22 and a pulling part 24.

The gravity part 22 is set on the second connecting part 144 to make the screen 16 leave from the rotating axis 1284 more quickly.

The pulling part 24 is set on the gravity part 22 for a user to pull the screen 16 by the pulling part 24 easily.

The above-described embodiments of the present invention are intended to be illustrative only. Numerous alternative embodiments may be devised by those skilled in the art without departing from the scope of the following claims.

What is claimed is:

1. A curtain, comprising:
a storage module having a first fixing unit, a second fixing unit, a shaft and a driving unit wherein the curtain is fixed to the wall by the first fixing unit and the second fixing unit, one end of the shaft is fixed on the first fixing unit, the driving unit has an elastic unit and a rotating axis wherein the elastic unit and the rotating unit are set on the second fixing unit, and the opposite end of the shaft is set on the rotating unit;
a rear unit having a first connecting part, a second connecting part and a plurality of the first sticking parts wherein the first connecting part connects to the shaft and the first sticking parts at a distance of the first length; and
a screen having a plurality of second sticking parts which stick to the first sticking parts and the second sticking parts are at a distance of the second length which is longer than the first length to form a roman shades by the screen on the rear unit;
wherein the rear unit and the screen are stored in the storage module by the elastic unit and the rotating shaft and leave from the rotating shaft.

2. The curtain as claimed in claim 1, wherein the curtain further includes colloid which can make the rear unit and the screen stick together.

3. The curtain as claimed in claim 1, wherein the curtain further includes a gravity part and a pulling part, and the gravity part is set on the second connecting part, and the pulling part is set on the gravity part.

4. The curtain as claimed in claim 1, wherein the curtain further includes a hole which is set on the first fixing unit, and a telescopic axis which is closed to the hole and connects to the hole oppositely.

5. The curtain as claimed in claim 1, wherein the elastic unit has a spring and two blocks, and one end of the spring is set on the second fixing unit, and the opposite end of the spring is set on the rotating shaft.

6. The curtain as claimed in claim 1, wherein the rotating shaft includes a rolling unit, an axis and a linking-up unit, the rolling unit connects to the spring, the axis combines with the rolling unit, one side of the linking-up unit connects to the axis, and the other side of the linking-up unit connects to the shaft.
